(19) United States
(12) Patent Application Publication
(10) Pub. No.: US 2017/0270485 A1
(43) Pub. Date: Sep. 21, 2017

(54) JOB POSTING, RESUME CREATION/MANAGEMENT AND APPLICANT TRACKING SYSTEM AND METHOD

(71) Applicant: Mark Meier, Edmonton (CA)

(72) Inventor: Mark Meier, Edmonton (CA)

(21) Appl. No.: 15/462,437

(22) Filed: Mar. 17, 2017

Related U.S. Application Data
(60) Provisional application No. 62/310,325, filed on Mar. 18, 2016.

(51) Int. Cl. G06Q 10/10; H04L 29/06; G06Q 10/06

(52) U.S. Cl. CPC G06Q 10/1053; G06Q 10/06398; H04L 63/105

(57) ABSTRACT

A system and method for storing resumes and job posting using a common skills database is provided, including: a server configured to operate a candidate interface module and a recruiter interface module; the skills database accessible by the candidate interface module and the recruiter interface module; the candidate interface module configured to store job postings including one or more skills from the skills database; and the recruiter interface module configured to store resumes including one or more skill from the skills database.

### CROSS REFERENCE TO RELATED APPLICATIONS

This application claims the priority benefit of U.S. Provisional Patent Application No. 62/310,325, filed Mar. 18, 2016, the entire contents of which are incorporated herein by reference.

### FIELD OF THE INVENTION

The invention relates to computer-implemented recruiting, resume management, resume submission, applicant tracking systems and job posting systems and methods.

### BACKGROUND

In the field of recruiting, individuals who are looking for work are called “candidates” and when they apply to a job posting they are referred to as “applicants”. Organizations looking to hire people typically publicize their job postings in a variety of mediums to attract candidates to the jobs. These organizations often post their vacant jobs on job board websites and may hire recruiters (either as employees of the organization or third party contractors) or use available recruiting websites. Candidates that use recruiting websites are not typically charged a fee to apply to jobs posted at the site. Organizations or recruiters are typically charged a fee to use recruiting websites and post jobs at the site and to use tools to source and manage candidates that apply to jobs.

One problem with the recruiting industry is the lack of standards. For example, the definition of a “Marketing Manager” position usually differs from one organization to another. While there are common skills and elements that a Marketing Manager must have to work at any organization, even the description of those skills and elements is typically not the same in any job postings for a Marketing Manager by different organizations. The process used by recruiters and organizations, from identification of a vacant position to filling the vacant position, is somewhat standardized (approx. 80% the same) although the details of each step are different for every organization.

The lack of standards in recruiting makes searching difficult. Recruiting products and websites are designed with the ability to enter any character string (called “free form text”), into a keyword search, a resume, job posting document, or data field in an Applicant Tracking System. Using free-form text allows spelling mistakes to be entered as well. Since there is no certainty on what words appear in to a document (resume or job posting), there is no guarantee that a keyword search will produce a proper match or be accurate.

When a free form text keyword search is performed against these documents, it often produces unpredictable results, for example, because it finds too many matches (e.g. looking for “his” also returns “this”, “history”, etc.); if the search keyword is spelled incorrectly a keyword match will not be found; or when they search for skills, too many non-skill results are returned making it difficult for the recruiter to focus only on skills.

When candidates create their resume, it is normally done via a word processing program (like Microsoft Word) and this resume becomes the candidate's master copy. On recruiting websites, when a candidate applies to a job, they typically upload their resume and the candidate is also asked to fill in some profile information that is stored in a database record for the candidate. However, the master copy of their resume still remains in Microsoft Word on the candidate's home computer. This may result in the uploaded version becoming stale and out-of-date quickly.

Some recruiting websites ask the candidate to upload their resume and then also add a separate list of their skills into the website database. These skills are not part of the candidate's resume, and rather are supplementary information on the recruiting website. These recruiting websites use an incomplete skills list (a “drop-down” list) that can be selected to add their skills to the website database. However the skills available for selection are not well described and they are not mandatory as part of the application process. Therefore the recruiter still relies on the candidate's Microsoft Word or PDF copy of the resume to perform free form text search for keywords, which as described above, is error prone.

There remains a need in the art for a recruiting, resume management, resume submission, applicant tracking systems and job posting system which may mitigate the difficulties of the prior art.

### SUMMARY OF THE INVENTION

In one aspect, the invention may comprise a computer-implemented method of matching candidates to job postings, comprising the steps of:
(a) matching at least one candidate resume selected from a plurality of resumes stored in a database, each resume comprising a plurality of components, to at least one job posting selected from a plurality of job postings stored in a database, each job posting comprising a plurality of job requirements;
(b) wherein one job requirement comprises at least one skill and one resume component comprises at least one skill, both selected from a common skills database; and
(c) generating a match indicator indicative of a degree of match between the at least one resume and the at least one job posting by comparing each of the job requirements with a corresponding resume component.

In another aspect, the invention may comprise a system for operating a recruiting process whereby a plurality of job postings and a plurality of candidate resumes can be processed, comprising:
(a) a server configured to operate a candidate interface module and a recruiter interface module;
(b) a resume database for storing resumes, a job postings database for storing job postings, and a common skills database accessible by the candidate interface module and the recruiter interface module;
(c) wherein the candidate interface module is configured to create a resume and store it in the resume database, each resume comprising a plurality of components, wherein one component is at least one skill selected from the skills database;
(d) wherein the recruiter interface module is configured to create a job posting and store it in the job postings database, each job posting comprising a plurality of job requirements, wherein one job requirement is at least one skill selected from the skills database; and
(e) a processor configured to search and match resumes and job postings and determine a match indicator indicative of a degree of match between a resume and a job posting, at the request of either the candidate interface module or the recruiter interface module.

### DESCRIPTION OF THE FIGURES

FIG. 1 is a representation of an embodiment of the system according to the invention.

FIG. 2 is an embodiment of a web page for a recruiter to use the system according to the invention.

FIG. 3 is an embodiment of a web page for a recruiter to search resumes using the system, showing search fields for different resume components.

FIG. 4 is an embodiment of a web page for a recruiter to prepare a new job posting using a job posting template.

FIG. 5 is an embodiment of a web page for a recruiter to review all job postings by all recruiters for an entity.

FIG. 6 is an embodiment of a web page for a recruiter to review all applicants for a job posting.

FIG. 7 is an embodiment of a web page for a recruiter to preview a resume of a candidate for a job posting in a selected format.

FIG. 8 is an embodiment of a web page for a recruiter to preview a resume of a candidate for a job posting in an alternative format.

FIG. 9 is an embodiment of a web page for a recruiter to select a format for review of a resume of a candidate for a job posting.

FIGS. 10a thru 10e are an embodiment of job posting screens including examples of a standard job (10d) and RFP job (10e) are shown, including an example of the skills section for a job noting Responsibilities and skills needed for each responsibility. In an RFP related job posting, the skills section of the job would show RFP related details instead of Responsibilities and skills, as shown in FIG. 10e.

FIG. 11 is an embodiment of a web page presented to a candidate when accessing the system to build a resume.

FIG. 12 is an embodiment of a resume preference box presented to the candidate when building a resume.

FIG. 13 is an embodiment of a display of the Contact Information component for a candidate building a resume.

FIG. 14 is an embodiment of a display for editing Contact Information sub-components for a job candidate.

FIG. 15 is an embodiment of an input screen for an executive summary of a resume for a candidate.

FIG. 16 is an embodiment of an input screen for a career objectives statement of a resume for a candidate.

FIG. 17 is an embodiment of a preview screen for a candidate of a resume built using one embodiment of a system.

FIG. 18 is an embodiment of an input screen for Education component data for a resume of a candidate.

FIG. 19 is an embodiment of an input screen for Work Experience component data.

FIG. 20 is an embodiment of a second input screen for Work Experience component data including accomplishments and skills.

FIG. 21 is an embodiment of a preview of a partially complete resume.

FIG. 22 is an embodiment of a file management screen (upload resume selector) for an uploaded resume.

FIG. 23 is an embodiment of an upload resume screen for a candidate.

FIG. 24 is an embodiment of an input screen for uploading a sample resume.

FIG. 25 is an embodiment of a screen showing the work needed after an uploaded resume has been parsed using a resume parser. The resume was parsed and pre-filled into certain resume fields. The yield sign (warning) symbols in front of the various sections below indicate which sections were pre-filled from parsing. Warning symbols indicate the candidate should click on them to verify/edit the data.

FIG. 26 is an embodiment of a screen showing a representation of an Education component screen after parsing, allowing the candidate to edit the parsed information. Sub-components (displaying the warning symbol) can be edited and verified

FIG. 27 is an embodiment of a screen showing a representation of the Education component after parsed sub-components are edited, verified and saved—the warnings disappear.

FIG. 28 is an embodiment of a screen showing a representation of a Work Experience component after parsing showing unverified sub-components. Sub-components (displaying the warning symbol) can be edited and verified.

FIG. 29 is an embodiment of a screen showing a representation of a Work Experience component after parsed sub-components are edited, verified and saved—the warnings disappear.

FIGS. 30a and 30b are an embodiment of a screen showing a resume preview where a candidate selects the Education and Work Experience sub-components they want added in the left menu, and the Resume Preview on the right shows what the resume currently looks like after changes were made to the resume.

FIG. 31 is an embodiment of a screen by which a candidate's resume can be shared and made accessible to recruiters.

FIGS. 32a and 32b are embodiments of a screen showing how a resume compares to the job requirements of a job posting. Notice some criteria did not match producing warnings or errors and explaining why. This feature can be invoked by a recruiter (to see how close a candidate resume matches a job), or by a candidate (to see how close their resume matches a job).

FIG. 33 is an embodiment of a screen showing how skills are selected by a candidate for inclusion in a resume. The top half of the screen from a sample resume Work Experience section, with the work details and summary information filled-in

FIG. 34 is an embodiment of a screen showing the Work Experience component of the resume after the skills have been selected. The bottom half of the screen from a sample resume Work Experience component, showing Accomplishments and Skills that were added.

FIG. 35 is an embodiment of a screen showing how a candidate selects a target job posting matrix (from an RFP) that will be merged with the candidate's resume components.

FIG. 36 is an embodiment of a screen showing the job posting matrix report after the candidate's resume details are merged into the job posting matrix.

### DESCRIPTION OF THE INVENTION

Generally, aspects or embodiments of the invention provide systems or methods of matching job postings and candidates. The system may be used by a recruiter to post job postings and identify suitable candidates, and the system may be used by a job-seeking candidate to post a resume and identify suitable job postings. As used herein, the term “job” means an employment opportunity and a “candidate” is an individual who is seeking a job. A “resume” is a compilation of information describing a candidate which is relevant to a job or jobs. A “job posting” is a compilation of information describing a job and job requirements, which are the required or desirable characteristics of a candidate to be chosen for the job. A “recruiter” means the entity preparing a job posting and/or reviewing resumes to determine suitability for the job posting. The recruiter may be an individual employed or contracted by the hiring company, such as a human resources employee or a third party headhunter. In an embodiment of the invention, the recruiter could be a system which performs recruiting functions in an automated manner.

### The System

In one embodiment, a system according to the invention provides standardization to the recruiting process by using a predefined common skills database used by candidates to create resumes and used by recruiters to create the job postings. Skills are selected and added to the candidates resume from a drop-down list and are not entered via free-form text. Thus automated matching (by skills and/or other criteria) is possible and produces very accurate results. In one embodiment, the system may use a predefined set of all known job position types that also identifies the skills needed for each job position.

Resumes and job postings both include skills selected from a common skills database, therefore comparison and matching requests may be simpler and more accurate. The job postings and resumes are hosted on the system and are accessible to candidates and recruiters, respectively, at any time. The system may provide recruiters and candidates the ability to create and store Applicant Tracking data, which may be additional information about the candidate (by the recruiter) or recruiter (by the candidate) The additional information could be notes about a conversation, email correspondence, interview times, meetings, etc. It is there to capture information about the job and candidates so if a candidate applies on another job there are notes from the previous application by the candidate. Similarly, the candidate can capture notes about the job so if a similar job appears in the future the candidate can look back at their notes from the previous job.

Candidate resumes are stored in the system as a combination of components which correspond to different resume sections (i.e. skills, education, contact, location, work experience, etc.). A candidate resume is built using the common skills database, unique candidate data (eg. name and address) and other data. The system can display the resume in many different formats because it assembles the resume from the different components using a template output resume format. The system provides search screens that guide the user through the process of searching for information in the system. Searching is done directly against the candidate resume components, job posting requirements and supplementary applicant tracking data elements to produce a search result.

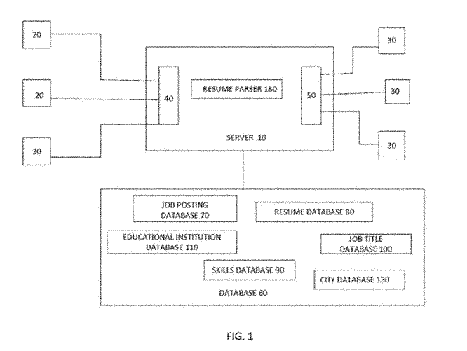

As shown schematically in FIG. 1, one embodiment of the system generally includes server 10, which includes a recruiter interface module 40 and candidate interface module 50 for communicating with recruiter computer 20 and candidate computer 30, respectively. Server 10 has access to database 60, which may store a variety of records including a job postings database 70, a resume database 80 and a skills database 90. The database may also store other relevant records such as a job title database 100, educational institution database 110, and location database 130. The job posting database 70 may include job requirements such as skills required or desired, salary offered, job location, commencement date, or any other information relevant to the job. The resume database 80 stores resume components as described herein. Server 10 may also include a resume parser 180 which may be used to allow a candidate to upload a resume and create compatible resume components stored in the system.

The database 60 may also include a jobs database, which is a complete listing of all known jobs, together with a listing of skills required for each job. Such listings may be prepared by the operator of the system, or derived from public sources, for example the U.S.A Standard Occupational Classification System, or Canadian National Occupation Classification System.

The recruiter interface module 40 and candidate interface module 50 are configured to provide the creation of job postings and resumes, respectively, that include skills selected from skills database 90.

In one embodiment, the recruiter interface module and the candidate interface module both only allow a recruiter or a candidate to choose from a listing of data stored in a common database, which eliminates the possibility of input errors. At least the skills database 90, and preferably each of the information databases is the same for both the recruiter interface module 40 and candidate interface module 50, and allows both recruiters and candidates to select from the same set of skills, job titles, education institutions, and locations, for example. The system, by providing a common database wherever possible for use by candidates and recruiters, provides a useful tool for comparing a resume to a job posting.

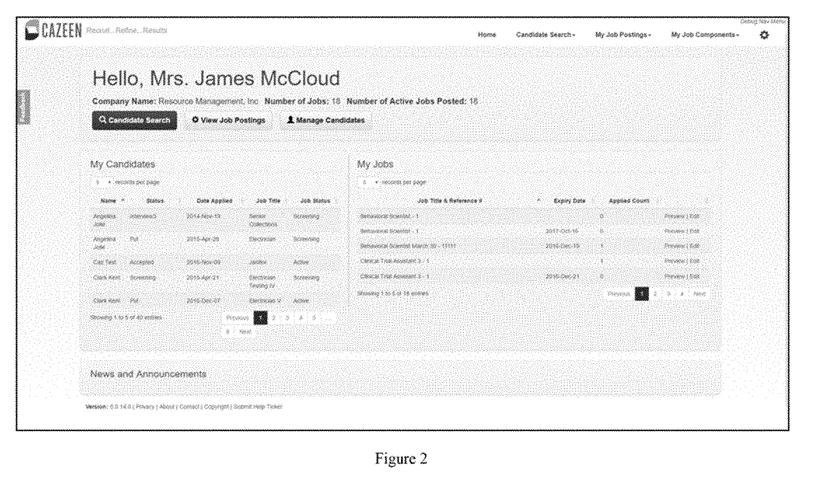

As shown in FIG. 2, a recruiter when accessing server 10, and after completing a logon process, may be presented with a home screen displaying current job postings in one column and candidates for those jobs in another. The recruiter is presented with selectable options, such as to conduct a search for candidates, manage job postings or manage the candidates.

### Job Postings

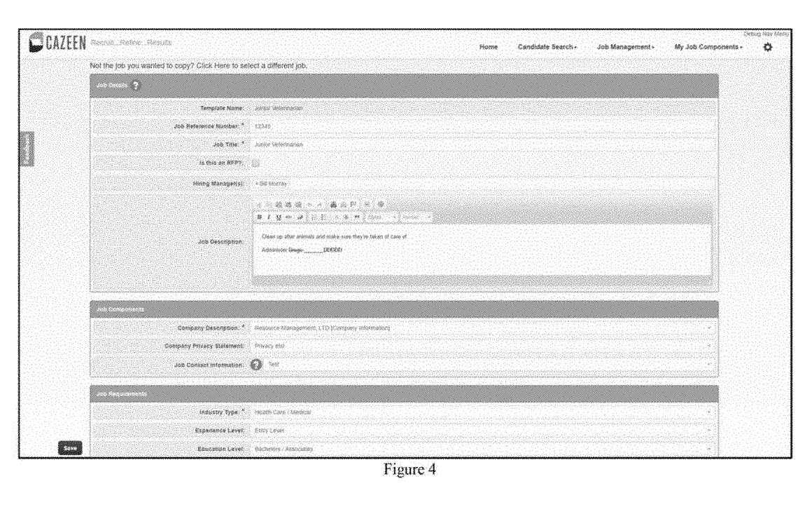

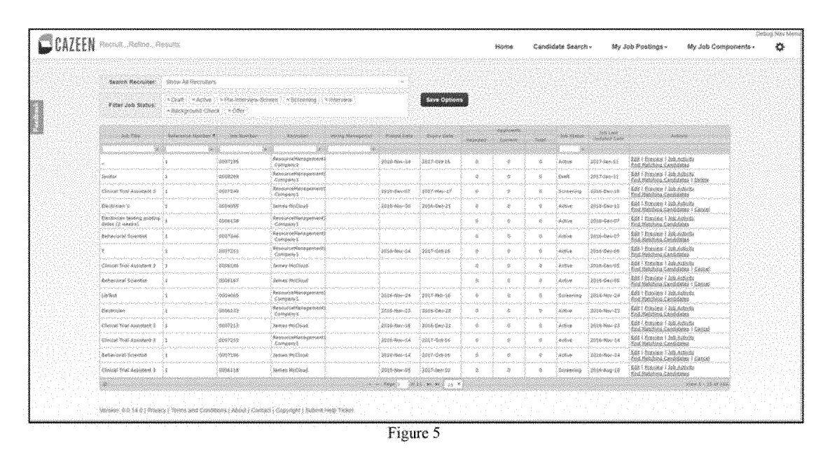

Job postings may be created, edited or viewed by a recruiter and comprised of certain data fields corresponding to job requirements. Preferably, a job posting may be based on a job template that can either be provided by the operator of server 10 or previously prepared by the recruiter. FIG. 4 shows a representation of one example of a job template. Job templates allow certain fields in the job posting to be pre-determined, i.e. already filled in, providing an efficient means of creating job postings, especially for job vacancies that occur frequently. Job templates are setup in the system to standardize and build a reusable posting that is accessible by all recruiters within the same entity, to create new job postings. Job posting templates may be created using any of the pre-existing data in any of the databases.

Individual recruiters based at a single organization, can view all of the postings created by the organization, as shown in FIG. 5, or only those postings for which the individual is responsible for. The job postings, or a subset thereof, can be selected and reviewed or edited.

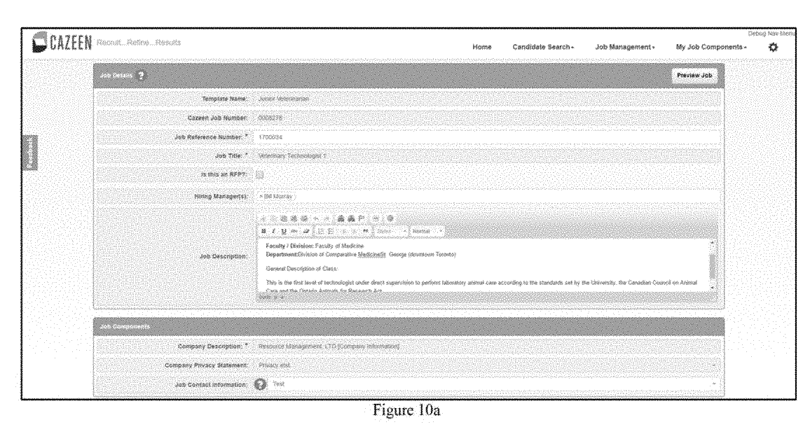

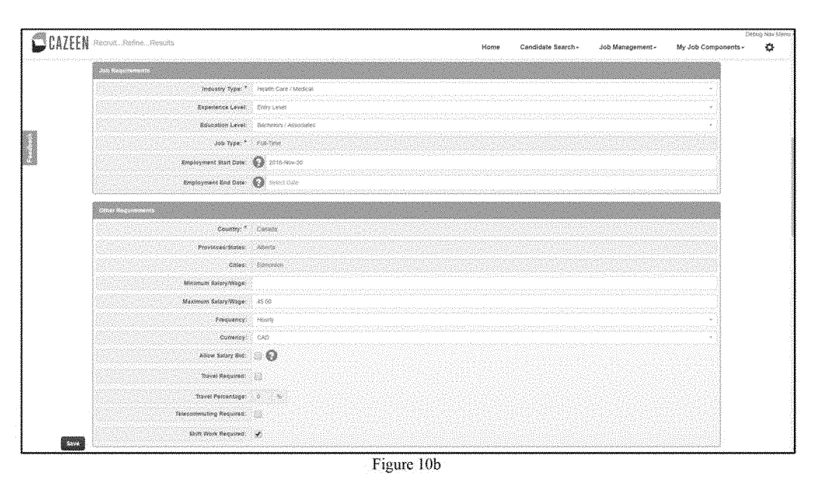

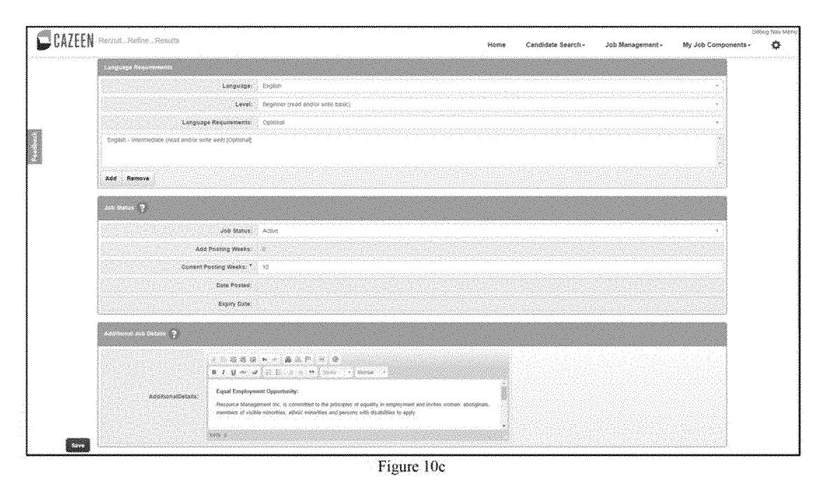

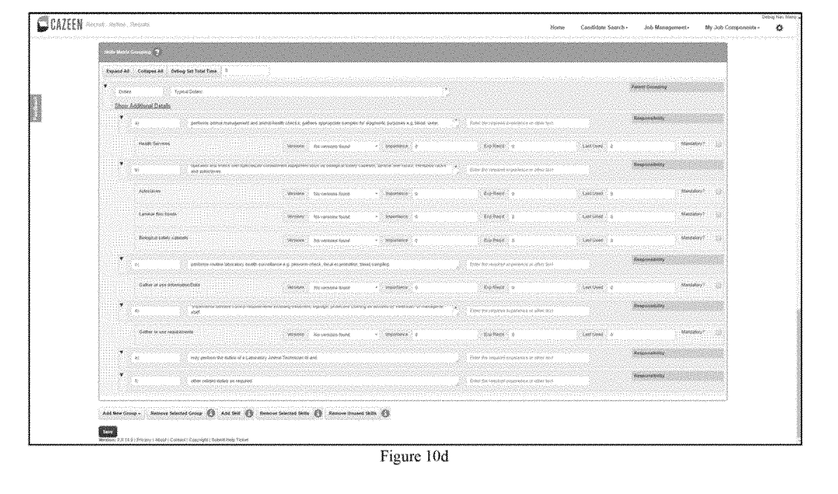

FIGS. 10a-d shows an example of an embodiment of a job template for a veterinary technologist. A list of required or preferred skills is provided, including a numerical value for the importance of the skill and the time, i.e. the amount of time spent by the candidate using the skill, as well as how many months ago the skill was last used. Importance is used as a weighting factor that may give some skills precedence over other skills during matching and ranking, to allow the recruiter to tailor search criteria in order to fine tune the search results. FIG. 10e shows an example of job posting in response to an Request for Proposal (RFP), which mandates certain job requirements which are derived from the RFP, instead of the Responsibilities fields of a non-RFP posting.

### Resumes

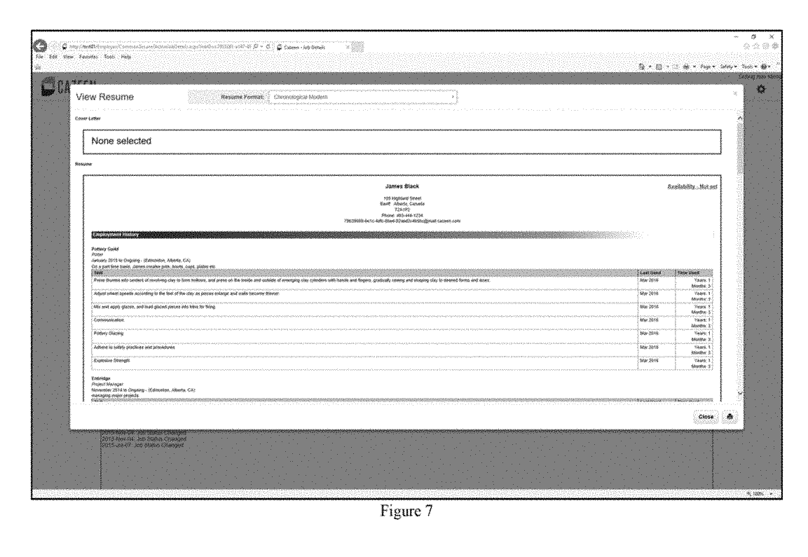

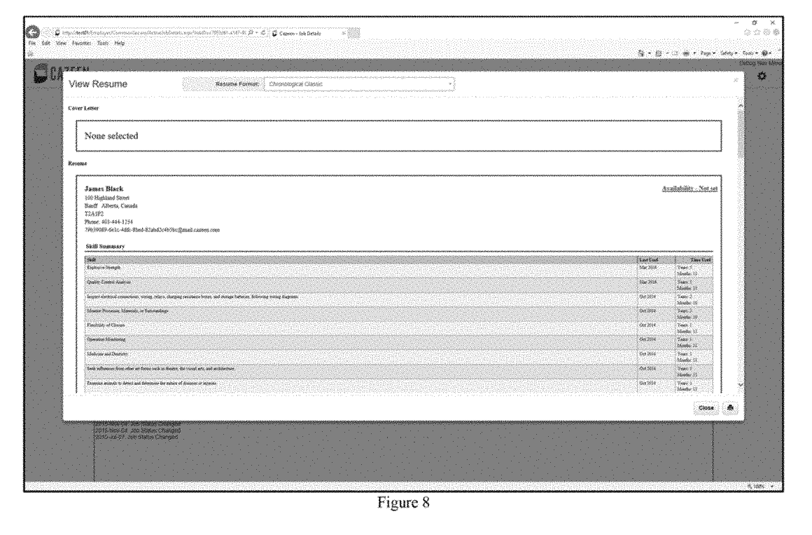

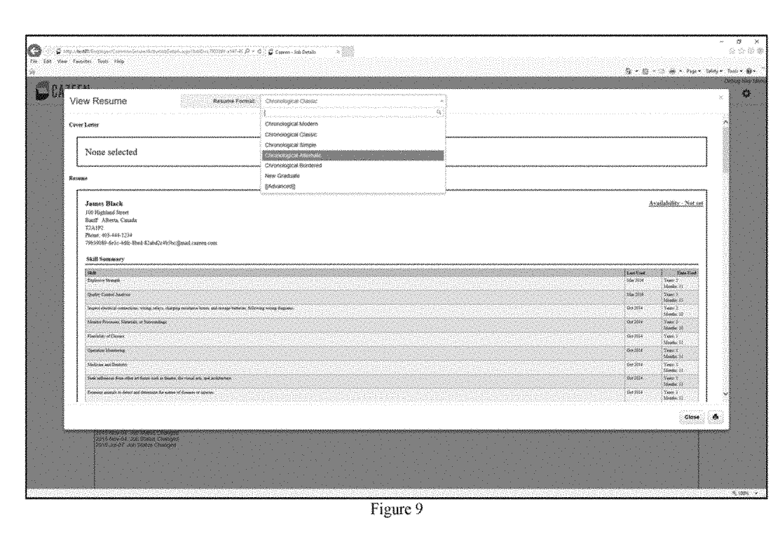

The system allows candidates to build a resume on the system or to upload a resume to the system. The candidate may select a resume template format from a drop-down list of alternative formats and uses this resume template format to view the resume and apply for a job. The resumes may be viewed by either the candidate or a recruiter in any provided format, regardless of the format in which the resume was created. FIGS. 7 and 8 show the same resume in alternative formats. As shown in FIG. 9, the recruiter may select from a drop down list which format to view a resume. The ability to view candidate resumes in the recruiters preferred format may make viewing the resumes more efficient for the recruiter as they can focus on a particular resume component(s)

Each resume comprises a plurality of components, each of which comprises relevant data or information. For example, a resume skills component may include many different skills, each of which may have associated information, such as length of time the candidate has had the skill, the date last used and level of proficiency.

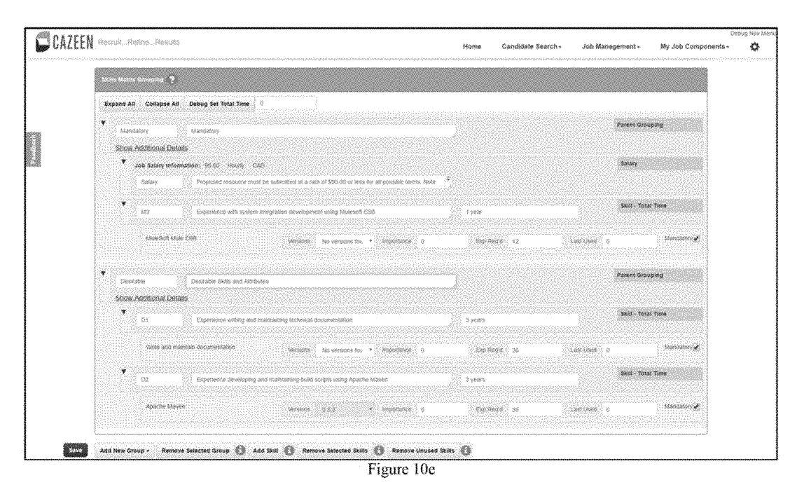

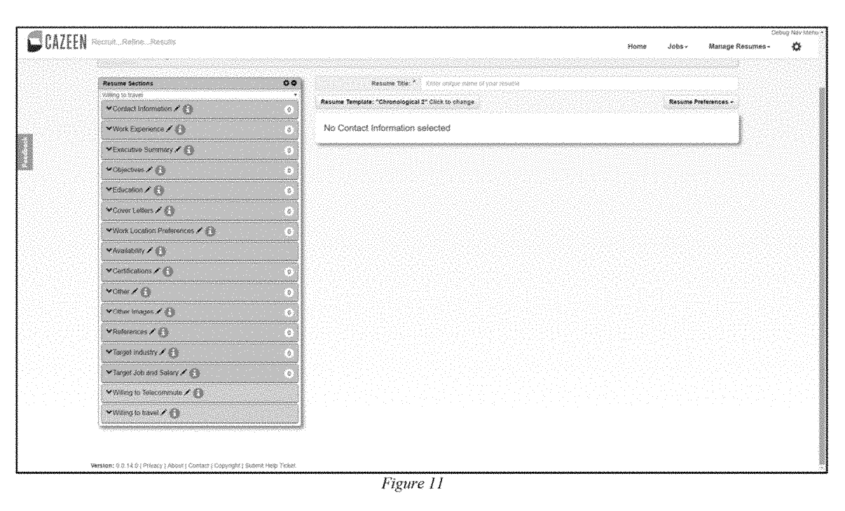

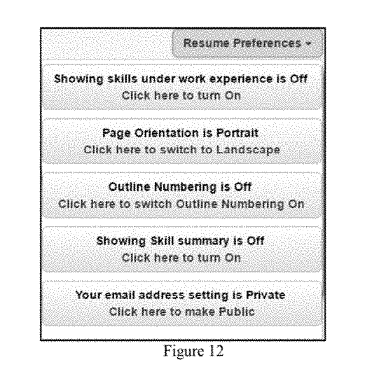

As shown in FIG. 11, once a candidate begins to build a resume, they are provided a screen from which they may begin entering information. The screen shows the different components in the left hand side, labelled as “Resume Sections”. As shown in FIG. 12, a preferences box is provided in which the candidate can opt to format the resume so skills appear in the Work Experience component or as a skills summary at the end of the resume. The candidate can also select to make the resume public or not.

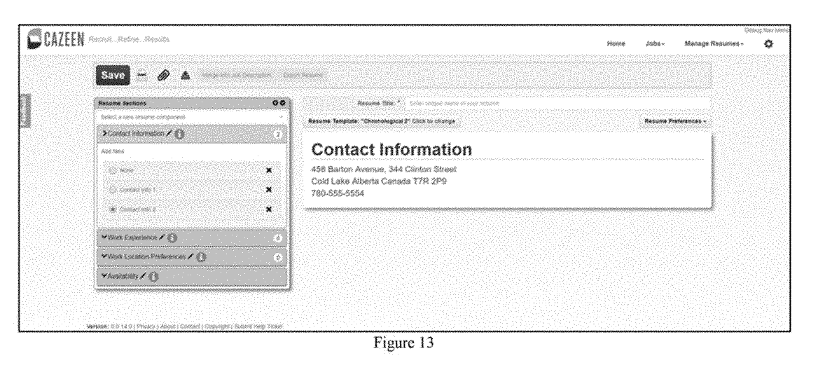

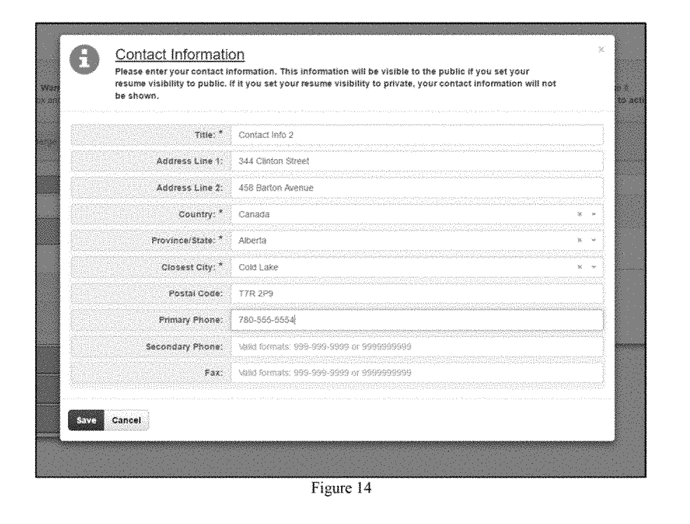

FIG. 13 shows a screen after the candidate has selected the “Contact Information” component, displaying data associated with contact information on the resume on the right hand side of the screen. FIG. 14 shows a pop-up allowing the candidate to enter or amend the data fields in the Contact Information component. The system is configured to access location database 130, where values are chosen from a drop-down list for fields such as the nearest municipality, county, state or province, and country. Selecting from a drop-down list prevents spelling errors from manual entry of data.

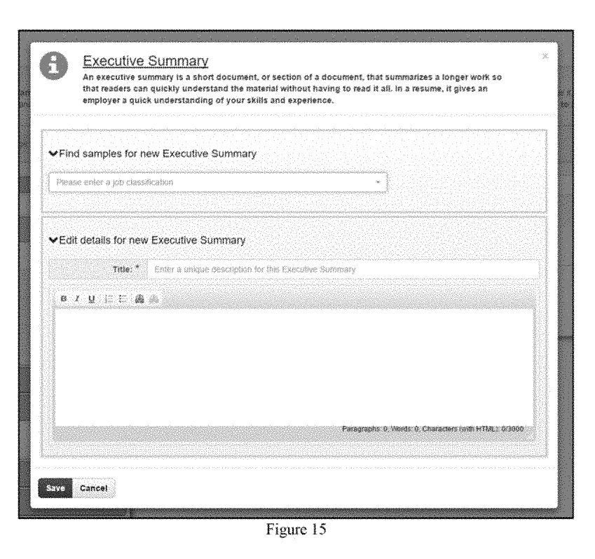

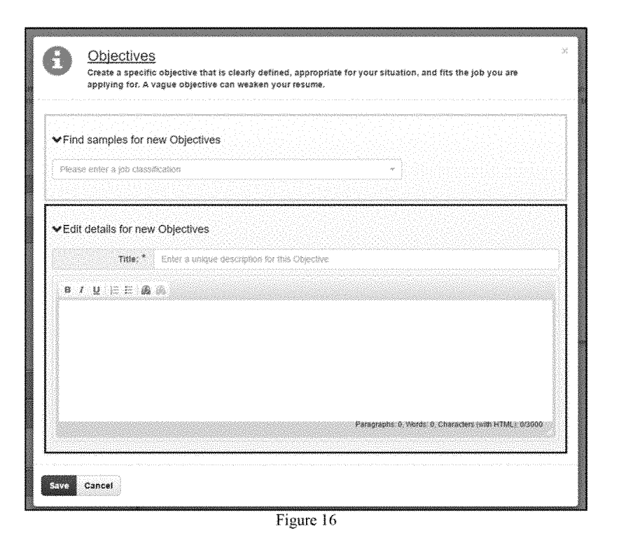

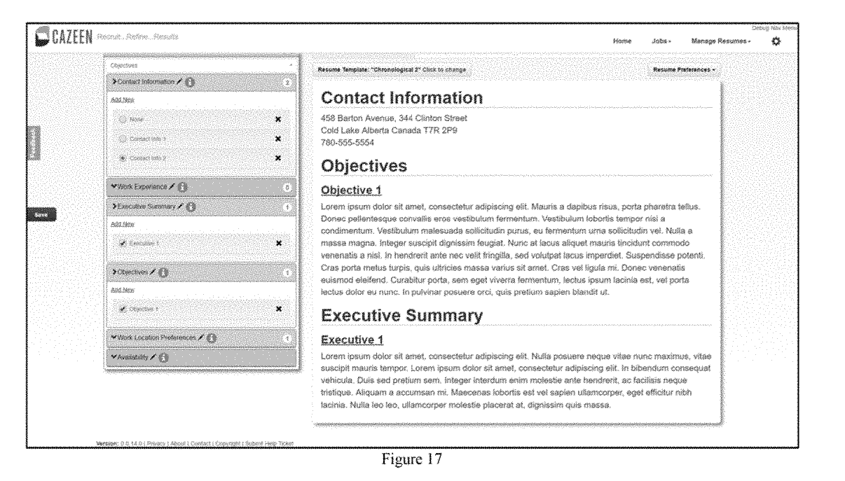

FIG. 15 shows a pop up window displayed by the system asking the candidate to enter or edit an executive summary. The user can select executive summary samples and copy them to the editable box on the screen, to speed up the process of creating this section. FIG. 16 shows a pop up window displayed by the system to allow the candidate to enter or edit their career objectives. The user can select objective samples and copy them to the editable box on the screen, to speed up the process of creating this section. FIG. 17 shows a screen displaying a preview of a resume based on the chosen output format template.

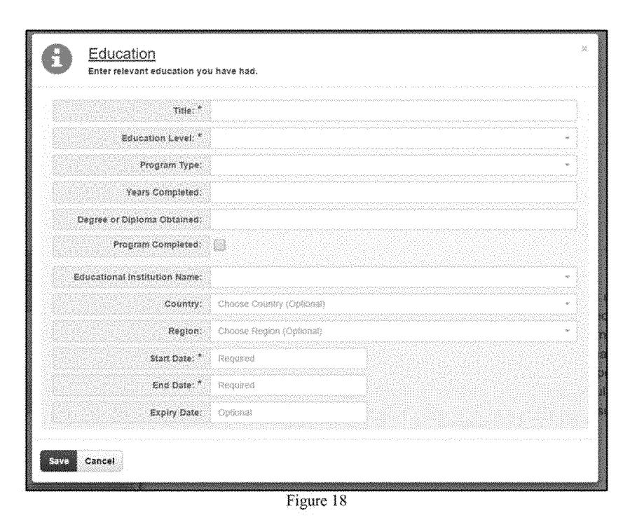

FIG. 18 shows a window by which a candidate can enter their education information in the Education component. The system is configured to access educational institution database 110 so that particular universities or institutions, for example, can be selected from a drop down list. Geographic fields (e.g. Country or Region) can be used to filter the list of eligible educational institutions.

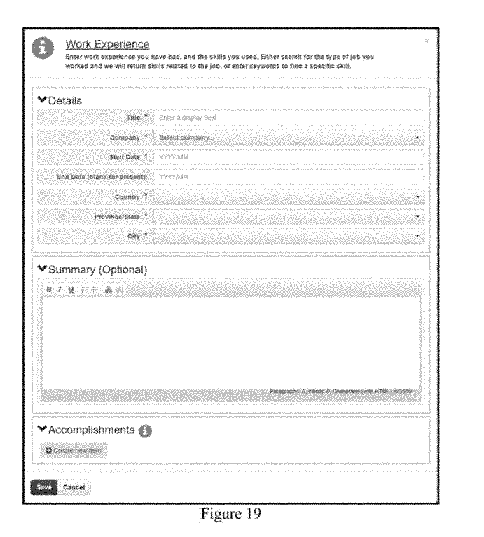

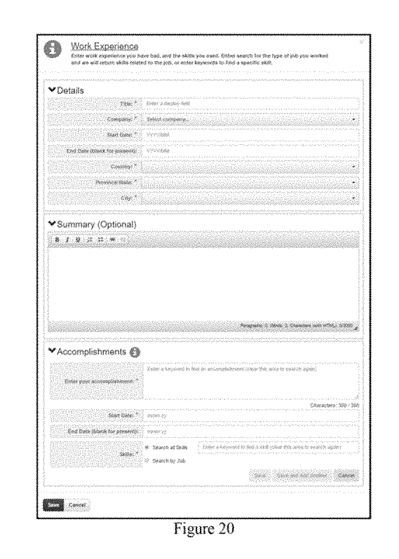

FIG. 19 shows a window where a candidate may record previous job information. FIG. 20 shows additional data entry fields in the Work Experience screen where the candidate can add particulars about their previous work experiences, including specific accomplishments achieved and the skills learned during each work experience. The candidate can select a job from the jobs database. This narrows down the list of accomplishments and skills that the candidate can select when documenting their work experience and allows for consistency within the system. FIG. 21 shows a screen displaying a preview of a resume to the candidate.

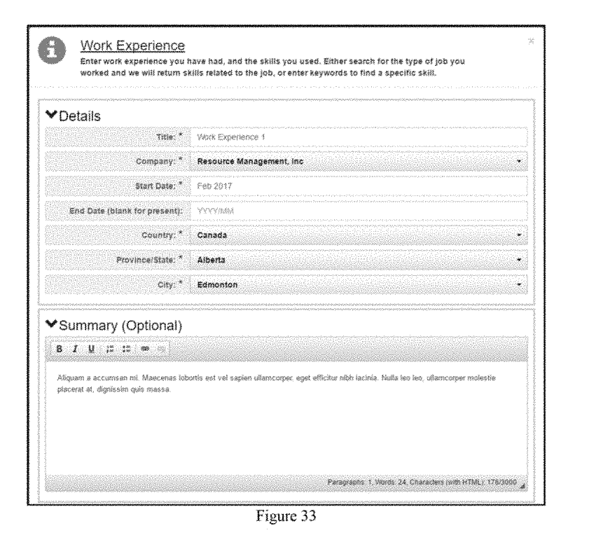

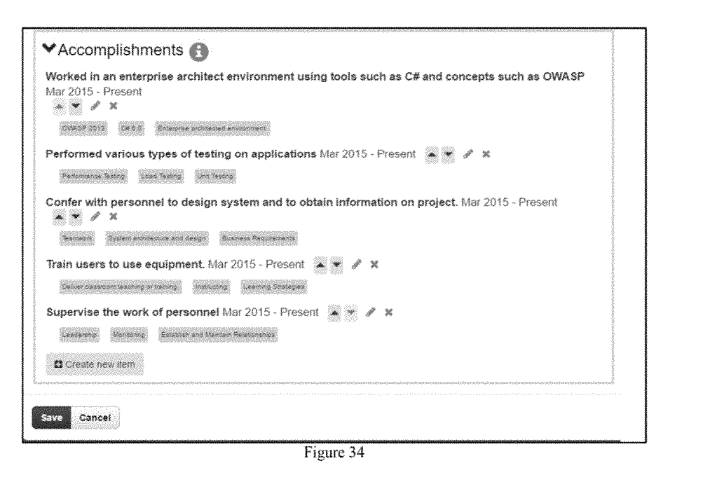

FIGS. 33 and 34 display the Work Experience section which describes the work performed by the candidate for a period of time. This screen allows the user to enter in their accomplishments achieved and skills learned for each work experience. The system provides a comprehensive list of accomplishments and skills that can be selected when building a work experience section. When editing or creating a resume, the candidate can pre-select a job to narrow down the list of accomplishments and skills to choose from. If the job is not specified, the entire database is searched. As the candidate enters a portion of the accomplishment it will display the closest matches. The candidate can either select one from the displayed list or type in a custom accomplishment in the screen field. The candidate can change the date range of each accomplishment. Then the candidate enters the skill. As the candidate enters a portion of the skill it will display the closest matches. The candidate then selects a skill from the list shown, or if there are no valid matches, they can “add” a new custom skill. Custom skills which are added by a candidate may be reviewed by the operator of the server 10 to validate the custom skill. FIG. 34 displays the resume after the skills have been added. Candidates, like recruiters, can change the format of their resume by selecting from a menu. Additional features may be coded in the system to allow skills to be searched or selected based on categories so that the appropriate skill can be found, and the candidate can specify their experience level for each skill based on a ranking of 1 to 5, 5 being the greatest amount of experience.

In one embodiment, because a resume is stored in the system as a compilation of components, the resume may be retrieved from the resume database and displayed on the screen using a viewing template formatted in a specific way. Many different viewing templates can be created to display the resume is whatever format that the template is designed to show the resume. The candidate or recruiter can use these different viewing templates to see the resume in their preferred format.

The use of resume components also facilitates creation and storage of variant resumes. For example, a candidate may have many different executive summaries, work objectives, potential locations that they want to work in, many contact (address) records, or many work experience records, each tailored or intended by the candidate to be used for different job searches. To create a variant resume, a candidate could create a variant component of a particular section and thus variant resumes would use different variant components in different combinations. When a candidate updates a data field in the database, it will update in all variant components which includes that data field, therefore all variant resumes that use those variant components will include the updated information.

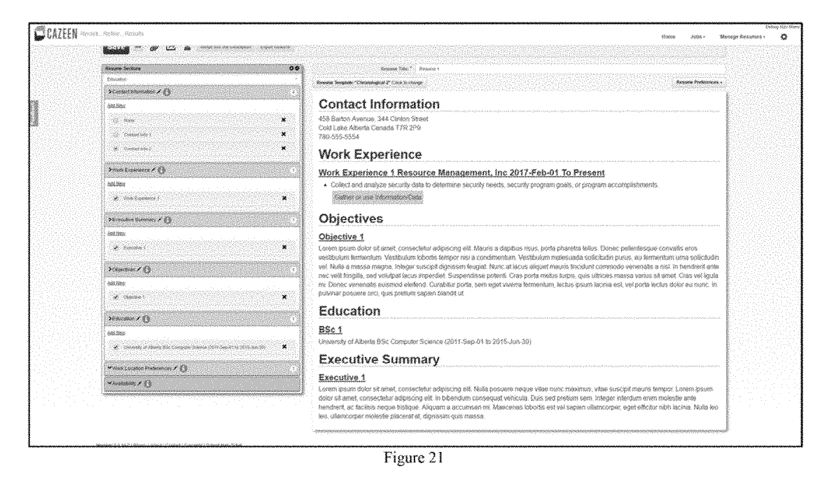

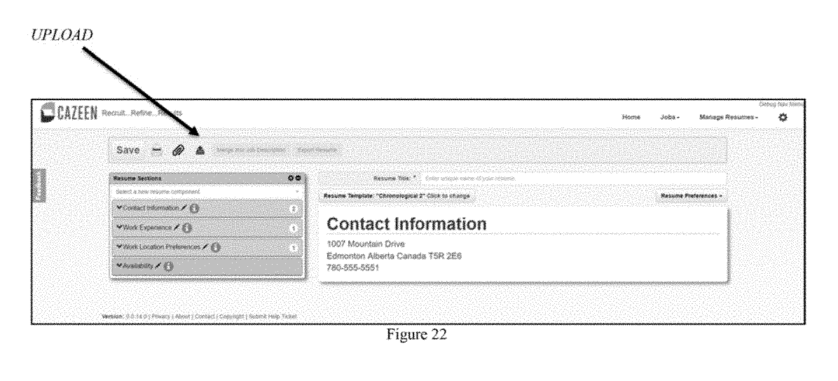

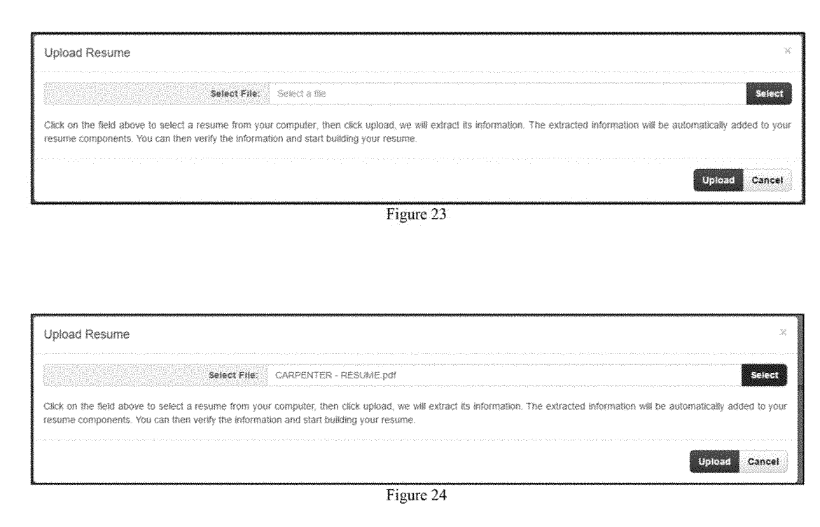

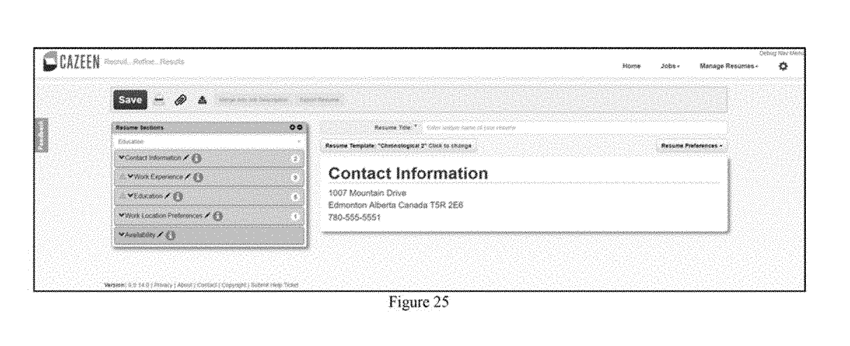

FIGS. 22, 23, and 24 display the screens shown to a candidate who desires to upload a resume, instead of using the system to build a resume. In one embodiment, the uploaded resume may be parsed by resume parser 180. The resume parser 180 reviews the uploaded resume and attempts to fill data fields in the different resume components. Differences or empty fields may be highlighted to the candidate by warning indicators. FIG. 25 displays resume components after parsing by the system. A number of warning indicators show the candidate that the parsed information in the components should be verified or edited. Once verified, those components are also displayed in the resume preview.

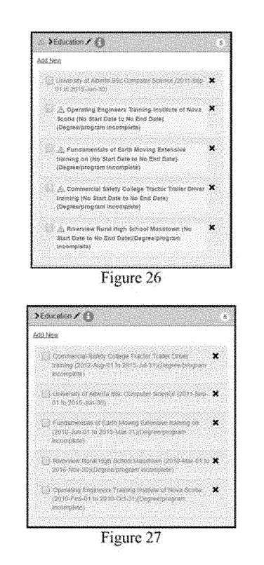

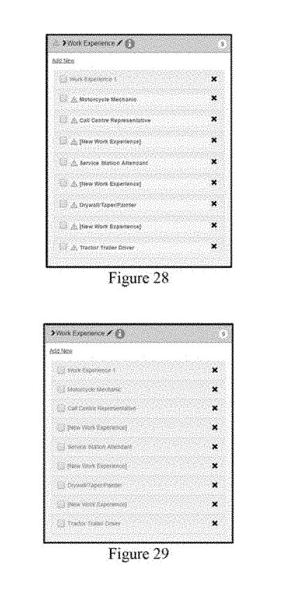

FIG. 26 shows a representation of an Education component after parsing, showing warning indicators that the information should be verified or edited. FIG. 27 displays the same information after the parsed information has been edited with the warning indicators removed. FIG. 28 shows a representation of a Work Experience component after parsing, showing warning indicators that the information should be verified or edited. FIG. 29 displays the same information after the parsed information has been edited with the warning indicators removed.

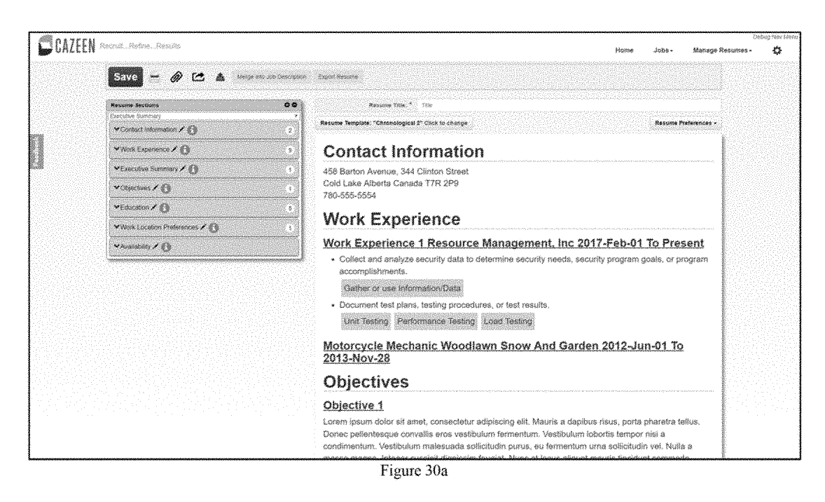

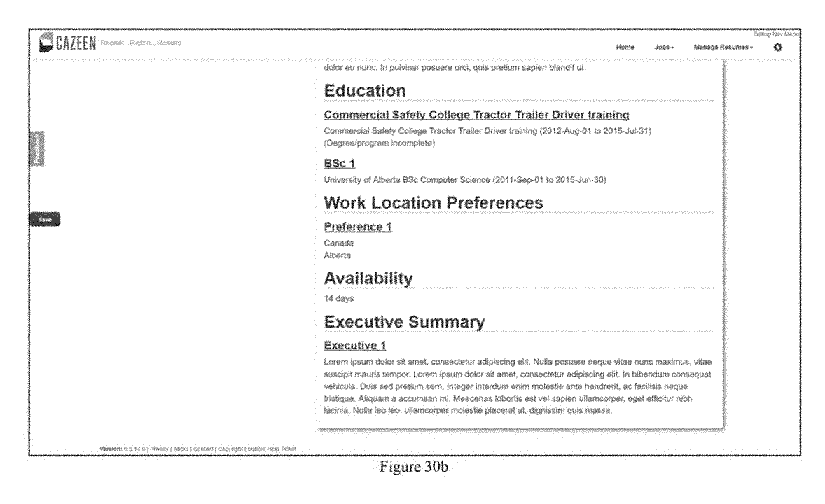

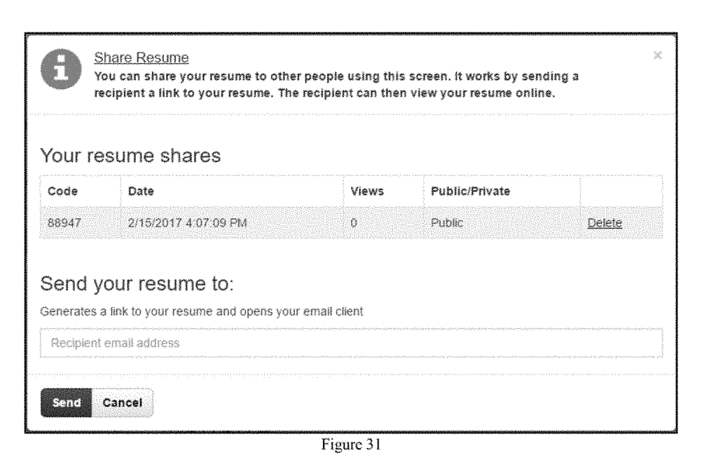

FIGS. 30a and 30b are a preview of a resume after the candidate selects resume components for inclusion in the final resume. Once the resume is complete either by uploading (and optionally parsing) or by manual creation, as shown in FIG. 31, the candidate is given the option to make the resume public or private, then to share it with certain individuals, such as recruiters. A hyperlink is provided which can be sent via email to a recruiter, for example, a recruiter, who can then directly access the resume. When the recipient views the resume, the system can send the candidate a notification that the resume has been viewed, and by who.

Candidates can thus control access to their resume at all times. In an embodiment of the invention, the candidate does not send an email to the recruiter with an attached resume, but instead sends a link to the recruiter to their resume on the system. To provide greater control, a candidate may provide the recruiter with a password to access the resume, and/or the link may be configured to expire after a certain time period. The candidate can still update the resume even after the link is sent to recruiter so that the recruiter views the most current copy of resume.

### Searching and Matching

One primary function of the system is to allow a recruiter to search for suitable candidates for a selected job posting. Of course, a candidate may use the system to search for suitable job postings in like manner to the details described below.

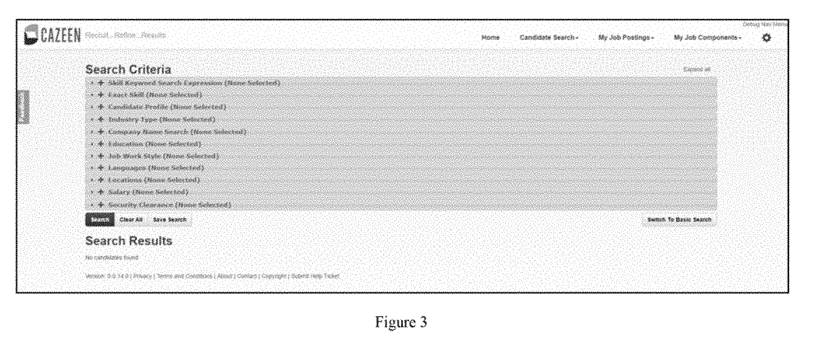

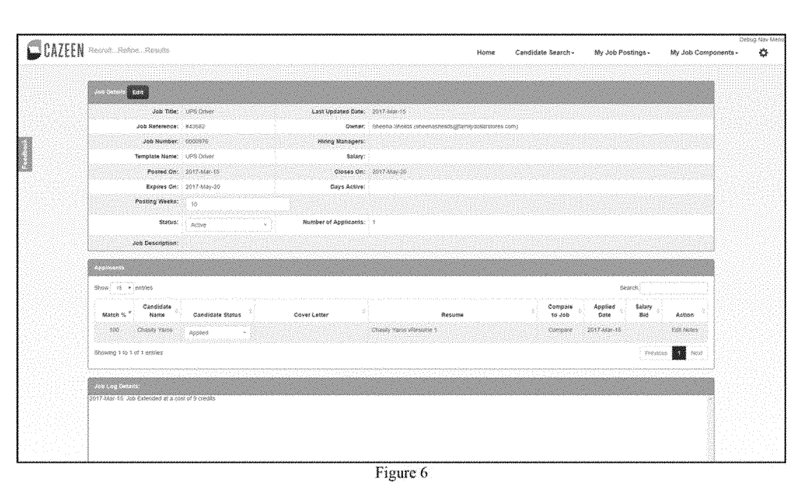

As shown in FIG. 3, a search screen is shown in which a recruiter can search through the resumes stored in the system for potential candidates based on various requirements, including a skill or skills, education, languages, salary expectations, or any requirement which a job posting may specify. A basic search may be a simple search based on a positive match for a single search criteria, for example, a search based on a single skill may deliver all candidates which list that skill on their resume, or combination of search criteria. In one embodiment, the search may provide binary results i.e. either positive or negative for a match in any data field. When the search is performed on server 10, a comparison is done on data fields in resume database 80 when searching for a candidate, or to data fields in job posting database 70 when searching for a job posting. This produces a search results list containing all the resumes (or the job postings) that were found on server 10 meeting the search criteria. FIG. 6 shows a list of candidates for a particular job posting, created in response to a search for suitable candidates.

In one embodiment, the search process includes a ranking or matching algorithm which looks at all resume components and determines how closely each resume matches to the job posting job requirements. This matching algorithm may be initiated by a recruiter to look for candidates to match a job posting, or a candidate to match their own resume against one or more job postings. In either case, the more resume components that match the corresponding job requirement, the higher the ranking. The components may all be given equal weighting, or certain components (i.e. skills, salary) may be assigned a higher weighting than other components, such that the ranking prioritizes the more important factors. There may be unequal weighting of certain data within a component. The results may be displayed in ascending or descending order of the relative match.

In one embodiment, the search and matching algorithm includes processing of all data fields in the resume components and job posting requirements, and then determines an indicator of relative match between a specified resume and a target job posting based on the individual data fields. A match indicator may be a simple yes/no result, for example, the search and match result may list all resumes that meet certain minimum requirements. In another embodiment, the match indicator may include a numerical value indicating a relative degree of match, such as a percentage value between a lower threshold value to 100% (every job requirement completely matched in a resume component). The match indicator may be determined by emphasizing requirements which are more important or relevant to the job posting and de-emphasizing less important or relevant requirements. Certain skills may be mandatory, i.e. the candidate must have the skill on their resume or the candidate's resume is not included in the search results. If a skill or attribute is optional, the candidate is not required to have the skill, but if they have the skill it will “bump up” and rank the candidate higher than other candidates that do not have the skill on their resume. Optional skills may also have different weighting as some may be more desirable than others. The result is a value or grade, such as a percentage value or a letter grade (A, B, C etc.) indicating how many data fields matched between the job requirements and the resume components, as adjusted for possible different weight given to some data fields over others.

For example, skills may be emphasized above other resume components. The more skills in an candidates resume that match the job posting skills, the higher they are ranked relative to other candidates with skills on their resume. So if one candidate resume has 9 of the 10 skills asked for in a job posting (90%/), they will rank higher than a candidate resume that has 8 out of the 10 skills (80%).

In one embodiment, the skills database includes additional information which a candidate can list in a resume, to allow more refined matching. For example, attached to each skill may be additional characteristics such as:
length of time used,
when the skill was last used, and
the proficiency level of the skill.
   These three characteristics are also used when matching skills. For example, if a job requires a skill “Problem solving” and a recruiter is looking for highly experienced candidates, the recruiter can include a search parameter for “length of time used” to 120 months, meaning a candidate should have 10 years of experience.

When a match indicator is produced by matching the job posting skills to the candidates resume skills, it may “bump up” the ranking for a candidate that has more experience than the job posting asks for, if the candidate has used the skill more recently than what is specified on the job posting, or if the candidate has a proficiency level greater than specified.

The search and match indicator algorithm may weigh other multiple factors, such as the education fields, salary, location, and availability. For example, the candidate can specify their desired work location (called target work location). If the candidate has a desired work location of San Francisco, but is applying to a job in Los Angeles, this candidate would be ranked slightly lower than other candidates that want to work in Los Angeles. A resume may indicate a date that the candidate specifies when they are available to start working if they are selected for the job. The sooner they can start after being selected the better their ranking will be relative to other candidates that are matched for the same job.

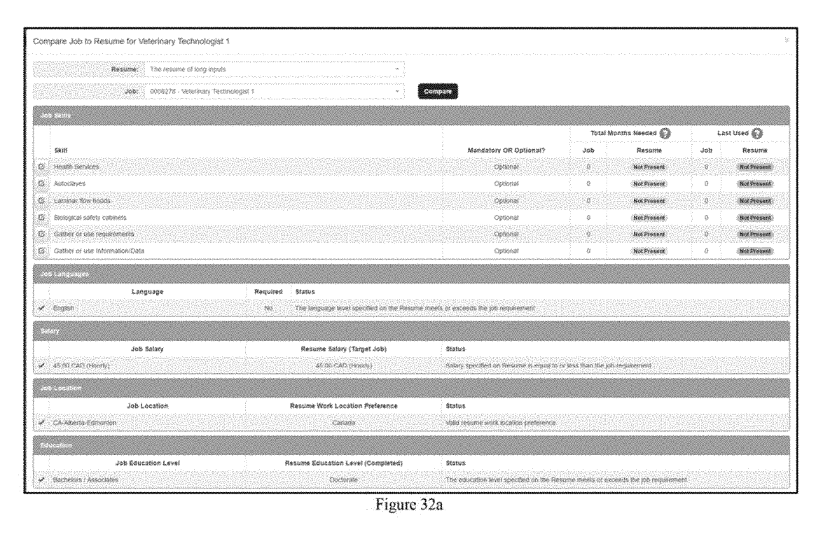

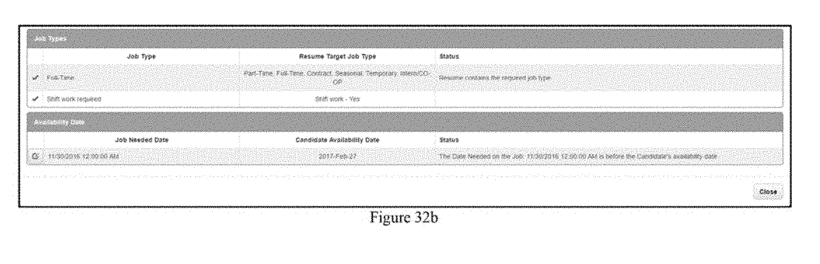

FIGS. 32a and 32b display how a job posting matches a resume. For each skill listed the system determines if the skill is present and for the amount of time required. Likewise, other component data in the resume including languages, location, education, salary and start dates are compared to the job posting. As the resume and job posting list skills selected from the same skills database, the system can easily determine if a skill is present. In one embodiment, the candidate can thus use this tool to determine if they are overqualified or underqualified for a particular position.

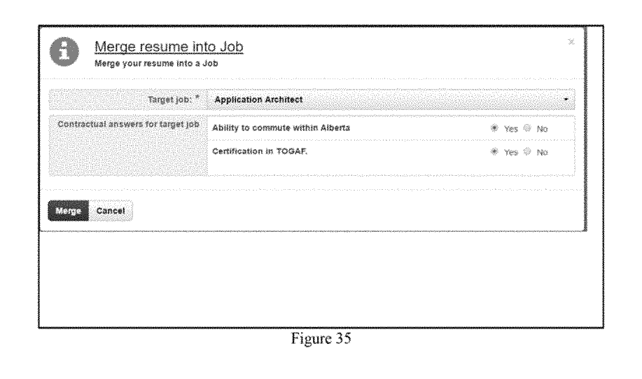

A search and matching process may also be initiated by a candidate. As shown in FIG. 35, a candidate may request the system to merge their resume into any selected job posting or group of postings in a merge, and receive a report regarding how closely their resume matches the job requirements of the job posting. This report may provide a match indicator similar or identical to that which a recruiter would receive when searching and matching candidates to a job posting. In response to a match rating, the candidate can then edit their resume to make changes to more closely match the job requirements of the job posting.

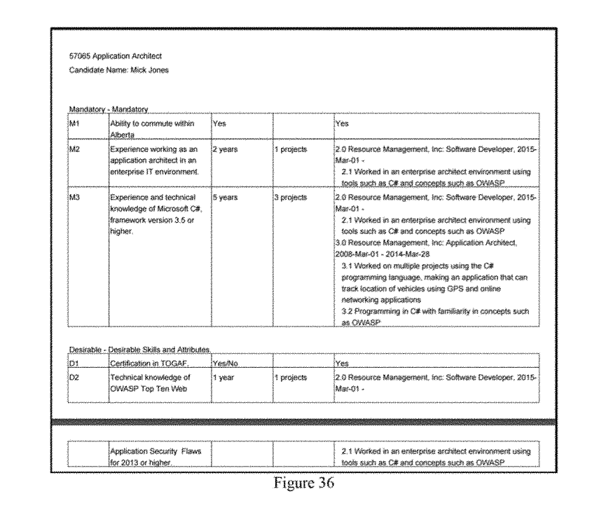

FIG. 36 is shows a screen showing a matrix report after the candidate's resume details are merged into a job posting which was derived from an RFP. Because RFPs typically have mandatory requirements, the matrix report after a candidate initiated merge will show a comparison between the candidate's resume information and those mandatory or desirable job requirements.

The system allows recruiters to search for information in a resume using consistent language, particularly in describing the skills of a candidate. As the skills are selected from a list, errors and spelling mistakes are avoided. Searches of resumes are more accurate because they use the defined skills from the skills database to match against the skills included in resumes. The skills database 90 supports the use of synonyms to make it easier for recruiters and candidates to find skills. Searching and matching utilizes synonyms when comparing resumes to job postings, to ensure matches are more inclusive and complete.

The system can be used for automatic screening and matching of resumes. Manual screening and matching of candidates to job postings is very time consuming and prone to human error. When recruiters manually review many resumes to verify skills and abilities, human fatigue becomes a factor which produces errors during resume screening. The system according to the invention can automatically screen and match resumes to job postings easily and quickly.

Candidates can use the system to keep resumes up to date by adding skills or employment information. The most recent version of the resume is saved on the system for access by the recruiters.

In an embodiment of the invention, the job posting may indicate that candidates are expected to provide a salary indication. This allows recruiters to provide for a bidding mechanism whereby the salary that will be paid the candidate is a factor as candidates will indicate a lower salary if there is demand for the job. When using this embodiment, recruiters may indicate a maximum salary amount on the job posting and candidates can specify their desired salary relative to the job posting salary amount.

In an embodiment of the invention the system can allow for making and storing comments. Recruiters can privately store comments relating to candidates (for example those that performed well or poorly in an interview). Likewise candidates can make comments about recruiters, or the entities which are trying to fill a job posting.

As a candidate's resume is stored on the system, the resume may be accessed using any computing system, including smart phones, tablets and laptops, allowing access to the resume from locations other than home.

### Definitions and Interpretation

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The following discussion provides a brief and general description of a suitable computing environment in which various embodiments of the system may be implemented. Although not required, embodiments will be described in the general context of computer-executable instructions, such as program applications, modules, objects or macros being executed by a computer. Those skilled in the relevant art will appreciate that the invention, or components thereof, can be practiced with other computing system configurations, including hand-held devices, multiprocessor systems, microprocessor-based or programmable consumer electronics, personal computers (“PCs”), network PCs, mini-computers, mainframe computers, mobile phones, smart phones, personal digital assistants, personal music players (like IPODs) and the like. The embodiments can be practiced in distributed computing environments where tasks or modules are performed by remote processing devices, which are linked through a communications network. In a distributed computing environment, program modules may be located in both local and remote memory storage devices.

As used herein, the terms “computer” and “server” are both computing systems as described in the following. A computing system may be used as a server including one or more processing units, system memories, and system buses that couple various system components including system memory to a processing unit. Computing system will at times be referred to in the singular herein, but this is not intended to limit the application to a single computing system since in typical embodiments, there will be more than one computing system or other device involved. Other computing systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

The computing system includes a system bus that can employ any known bus structures or architectures, including a memory bus with memory controller, a peripheral bus, and a local bus. The system also will have a memory which may include read-only memory (“ROM”) and random access memory (“RAM”). A basic input/output system (“BIOS”), which can form part of the ROM, contains basic routines that help transfer information between elements within the computing system, such as during startup.

The computing system also includes non-volatile memory. The non-volatile memory may take a variety of forms, for example a hard disk drive for reading from and writing to a hard disk, flash drive, and an optical disk drive; and a magnetic disk drive for reading from and writing to removable optical disks and magnetic disks, respectively. The optical disk can be a CD-ROM or BLU-RAY, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although computing systems may employ hard disks, optical disks and/or magnetic disks, those skilled in the relevant art will appreciate that other types of non-volatile computer-readable media that can store data accessible by a computer may be employed, such a magnetic cassettes, flash memory cards, digital video disks (“DVD”), Bernoulli cartridges, RAMs, ROMs, smart cards, etc.

Various program modules or application programs and/or data can be stored in the system memory. For example, the system memory may store an operating system, end user application interfaces, server applications, and one or more application program interfaces (“APIs”).

The system memory also includes one or more networking applications, for example a Web server application and/or Web client or browser application for permitting the computing system to exchange data with sources, such as clients operated by users and members via the Internet, corporate Intranets, or other networks as described below, as well as with other server applications on servers such as those further discussed below. The networking application in the preferred embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such those available from Mozilla, Google, Apple and Microsoft.

A computing system can operate in a networked environment using logical connections to one or more client computing systems and/or one or more database systems, such as one or more remote computers or networks. The computing system may be logically connected to one or more client computing systems and/or database systems under any known method of permitting computers to communicate, for example through a network such as a local area network (“LAN”) and/or a wide area network (“WAN”) including, for example, the Internet. Such networking environments are well known, including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, the computing system is connected to the LAN through an adapter or network interface card (communicatively linked to the system bus). When used in a WAN networking environment, the computing system may include an interface and modem (not shown) or other device, such as a network interface card, for establishing communications over the WAN/Internet.

In a networked environment, program modules, application programs, or data, or portions thereof, can be stored in the computing system for provision to the networked computers. In one embodiment, the computing system is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links.

While in most instances the computing system will operate automatically, where an end user application interface is provided, an operator can enter commands and information into the computing system through an end user application interface including input devices, such as a keyboard, and a pointing device, such as a mouse. Other input devices can include a microphone, joystick, scanner, etc. These and other input devices are connected to the processing unit through the end user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter (not shown). The computing system can include other output devices, such as speakers, printers, etc.

The present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product, including cloud based storage. The software modules in the computer program product may also be distributed electronically, via the Internet or otherwise, by transmission of a data signal (in which the software modules are embedded) such as embodied in a carrier wave.

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

While certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of“including” to be synonymous with “including but not limited to”, the mere usage of the phrase “including but not limited to” does not mean that the term “including” means something other than “including but not limited to”.

None of the Title, the Abstract, or any headings in this specification are to be taken as limiting in any way as the scope of the claimed invention(s). An Abstract has been included in this application merely as a required element. The title of the present application and headings of sections provided in the present application are for convenience only, and are not to be taken as limiting the disclosure in any way.

1. A computer-implemented method of matching candidates to job postings, comprising the steps of:
a. matching at least one candidate resume selected from a plurality of resumes stored in a database, each resume comprising a plurality of components, to at least one job posting selected from a plurality of job postings stored in a database, each job posting comprising a plurality of job requirements;
b. wherein one job requirement comprises at least one skill and one resume component comprises at least one skill, both selected from a common skills database; and
c. generating a match indicator indicative of a degree of match between the at least one resume and the at least one job posting by comparing each of the job requirements with a corresponding resume component.

2. The method of claim 1 wherein the matching step is performed for a plurality of resumes, which are then ranked by their match indicators.

3. The method of claim 1 wherein the resume components are each accorded different weighting in the matching step.

4. The method of claim 3 wherein the resume skill component includes information regarding one or more of: length of time used, when last used, and a proficiency level, and the matching step weighs the information in accordance with the job posting job requirements.

5. The method of claim 1 wherein the resume components may be viewed in one of a plurality of viewing format templates by either a candidate or a recruiter, regardless of the format in which the resume was created.

6. The method of claim 1 wherein the plurality of resumes comprises variant resumes for a candidate, produced by creating and combining a plurality of variant components.

7. The method of claim 1 wherein the match indicator comprises a positive/negative indicator for a minimum requirement, a grade indicating a relative degree of match, or a comparison matrix listing resume components against job requirements, or any combination thereof.

8. The method of claim 7 wherein the match indicator is generated in response to a search by a recruiter for all resumes which match a minimum requirement, which results in a list of candidate resumes each having a grade.

9. The method of claim 1 wherein a job posting may be created from a pre-defined job template.

10. The method of claim 1 wherein resume components and job requirements which share the same data are each created by selection from a common database.

11. The method of claim 10 wherein the common database comprises one or more of a job title database, a geographic location database, or an educational institution database.

12. The method of claim 1 comprising a further step of emailing a link to a resume to a recruiter at the request of candidate, which link comprises a security token and expiry date.

13. A system for operating a recruiting process whereby a plurality of job postings and a plurality of candidate resumes can be processed, comprising:
a server configured to operate a candidate interface module and a recruiter interface module;
a resume database for storing resumes, a job postings database for storing job postings, and a common skills database accessible by the candidate interface module and the recruiter interface module;
wherein the candidate interface module is configured to create a resume and store it in the resume database, each resume comprising a plurality of components, wherein one component is at least one skill selected from the skills database;
wherein the recruiter interface module is configured to create a job posting and store it in the job postings database, each job posting comprising a plurality of job requirements, wherein one job requirement is at least one skill selected from the skills database; and
a processor configured to search and match resumes and job postings and determine a match indicator indicative of a degree of match between a resume and a job posting, at the request of either the candidate interface module or the recruiter interface module.

14. The system of claim 13, wherein the match indicator comprises a positive/negative indicator for a minimum requirement, a grade indicating a relative degree of match, or a comparison matrix listing resume components against job requirements, or any combination thereof.

15. The system of claim 12 wherein the recruiter interface module is configured to allow entry of a rating of importance of a skill within a job posting.

16. The system of claim 12 wherein the recruiter interface module is configured to allow a recruiter to view a resume in one of a plurality of different viewing templates.

17. The system of claim 12 wherein the candidate interface module is configured to upload a resume for inclusion in the resume database and the server is configured to parse the uploaded resume.

18. The system of claim 16 wherein the server identifies those components of the resume needing completion or verification before being added to a resume stored in the system.

19. The system of claim 17 wherein the candidate interface module is configured to email a link to a resume to a recipient.

20. The system of claim 13 further comprising at least one job posting template.

21. The system of claim 13 wherein the candidate interface module is configured to allow a candidate to store a plurality of variant resumes in the resume database.

22. The system of claim 13 wherein the candidate interface module is configured to allow a candidate to control the level of privacy and security of their resume by indicating who can view their resume.

23. The system of claim 22 wherein the candidate can control the level of privacy and security of their resume by communicating a link to a recipient, which link includes a security token and expiry date.

24. The system of claim 13 further comprising a common database for resume components and job requirements which share the same data.

25. The system of claim 24 wherein the common database comprises one or more of a job title database, a geographic location database, or an educational institution database.
